(19) United States
(12) Patent Application Publication
(10) Pub. No.: US 2024/0086604 A1
(43) Pub. Date: Mar. 14, 2024

(54) SYSTEM AND METHOD FOR MICRO-OBJECT DENSITY DISTRIBUTION CONTROL WITH THE AID OF A DIGITAL COMPUTER

(71) Applicant: XEROX CORPORATION, NORWALK, CT (US)

(72) Inventors: Ion Matei, Mountain View, CA (US); Johan de Kleer, Los Altos, CA (US); Maksym Igorevich Zhenirovskyy, San Jose, CA (US)

(21) Appl. No.: 17/966,449

(22) Filed: Oct. 14, 2022

Related U.S. Application Data
(60) Provisional application No. 63/404,073, filed on Sep. 6, 2022.

(51) Int. Cl. G06F 30/3308

(52) U.S. Cl. CPC G06F 30/3308; G06F 2101/14; G06F 2111/14

(57) ABSTRACT

System and method that allow to control density distributions of multiple particles (micro-or-nano-sized objects) to desired positions are described. A kernel density estimation (KDE) is used as a proxy for the initial particle density distribution and an optimal control problem is defined and solved using this approximation. A sequence of electrode electric potentials is computed so that the initial particle distribution is shaped into a target distribution after applying this sequence over time. The optimal control cost function is defined in terms of an L2 metric, with the L2 function that is used to compute the error between the particle density at the end of a time horizon and a target density. The KDE depends on the predicted trajectories of a set of particles, where the trajectory of a single particle is determined by a lumped, 2D, capacitive-based, nonlinear model describing the particle's motion.

### FIELD

This application relates in general to micro-assembly control, and in particular, to a system and method for micro-object density distribution control with the aid of a digital computer.

### BACKGROUND

Micro- and nano-scale particle manipulation has received a lot of research interest. The degree to which control can be exercised over assembly of micro-objects, objects whose dimensions measure in microns, and nano-objects, objects whose dimensions measure in nanometers, can make a significant difference in a number of technologies, including in micro-fabrication, biology and medicine. For example, manufacturing of reconfigurable electrical circuits can be improved by being able to accurately control position of micro-objects such as capacitors and resistors to manufacture a circuit with a desired behavior. Similarly, production of photovoltaic solar cell arrays can benefit from being able to put photovoltaic cells with certain qualities into particular positions on the arrays. Such cells can be too small to allow for a desired placement of the cells via human or robotic manipulation, and another kind of transportation mechanism is needed. Micro-assembly and nano-assembly of particles can also be used to engineer the microstructure of materials, such as of biological cells being assembled into tissue. Many other technological fields exist where increasing control over assembly of micro-and-nano objects can provide significant benefits.

Existing techniques do not allow for control of movement of micro-and-nano-objects with the required degree of precision. For example, uncontrolled mechanical agitation is typically used for directed particle assembly. However, this technique fails to achieve the near 100% yield necessary for certain industrial applications, such as electronics assembly.

Likewise, in Wang et al., “Dielectrophoretic manipulation of cells with spiral electrodes,” Biophysical Journal, 72(4):1887-1899, 199, describes studying the effect of dielectrophoresis on cancer cells. This work assumes that the particles involved are spherical and small enough so that the electric field is not disturbed by their presence, limiting the applicability of the described techniques.

A control scheme for individual and ensemble control of colloids is described by Tara D. Edwards and Michael A. Bevan, “Controlling colloidal particles with electric fields.” Langmuir, 30(36):10793-10803, 2014. PMID: 24601635 (“Edwards”), the disclosure of which is incorporated by reference. In particular, Edwards shows how inhomogeneous electric fields are used to manipulate individual and ensembles of colloidal particles (1 μm to 3 μm diameter) in water and sodium hydroxide solutions through electrophoresis and electroosmosis. The relative size of the colloids to the electrodes employed to generate the field, the medium in which the particles were immersed, and the resulting mathematical models, do not allow the described techniques to be used in certain industrial applications. In particular, the described techniques are not suitable for assembling micro-objects even slightly larger than those discussed in the Edwards paper. Further, the control schemes used involve high frequency signals (MHz), which further limits the applicability of such techniques.

Similarly, Qian et al., “On-demand and location selective particle assembly via electrophoretic deposition for fabricating structures with particle-to-particle precision,” Langmuir, 31(12):3563-3568, 2015. PMID: 25314133, the disclosure of which is incorporated by reference, demonstrated single particle precision and location selective particle deposition, where electrophoretic forces are the primary drive for particle (2 μm polystyrene beads) manipulation. The control scheme employed was based on building large energy wells close to the desired location of the nano-particles. However, the described techniques does not allow for adequate sorting and placement of individual objects. Further, the described techniques do not allow to adequately manipulate asymmetric objects such as semiconductor chips, which require orientation control to be used to build up electronic systems.

Several works, such as Xue et al., “Optimal design of a colloidal self-assembly process,” IEEE Transactions on Control Systems Technology, 22(5):1956-1963, September 2014, and Xue et al., “Mdp based optimal control for a colloidal self-assembly system,” American Control Conference (ACC), 2013, pages 3397-3402, June 2013, describe controlling a stochastic colloidal assembly process that drive the system to the desired high-crystallinity state and that are based on a Markov-Decision Process optimal control policy. The dynamic model is based on actuator-parametrized Langevin equations. However, in these works, individual particles are not directly manipulated and how this approach can be used when assembling electrical circuits is unclear. Moreover, the size of the particles used (≈3 μm in diameter) is small to the extent that they pose little disturbance to the electric field that is completely shaped by an actuation potentials. In addition, the time scale for achieving the desired state would make the goal of high throughput using this approach challenging to achieve.

Other self-assembly control approaches, such as described by Grzelczak et al., “Directed self-assembly of nanoparticles,” ACS Nano, 4(7):3591-3605, 2010. PMID: 20568710; Paulson et al., “Control of self-assembly in micro- and nano-scale systems,” Journal of Process Control, 27:38-49, 2015; Mastrangeli et al., “Automated real-time control of fluidic self-assembly of microparticles,” Robotics and Automation (ICRA), 2014 IEEE International Conference on pages 5860-5865, May 2014; and Paulson et al., “Control of self-assembly in micro- and nano-scale systems,” Journal of Process Control, 27:38-49, 2015, do not, as they are, allow to easily scale the number of objects being moved.

Water-based solution in which particles are immersed is a popular choice of control medium, such as described by Edman et al., “Electric field directed assembly of an ingaas led onto silicon circuitry. IEEE Photonics Technology Letters, 12(9):1198-1200, September 2000 and Tolley et al., “Dynamically programmable fluidic assembly,” Applied Physics Letters, 93(25), 2008. In such cases, both electrophoretic forces as well as fluid motions of electro-osmotic flows are used to drive particles. However, water does not behave like a dielectric, hence cannot generate electric fields, resulting in lower forces for moving objects, thus significantly limiting the size of objects that can be moved using this setup.

Accurate control of cells, quantum dots and nano-wires bases on electroosmosis is used in Mathai et al., “Simultaneous positioning and orientation of single nano-wires using flow control,” RSC Adv., 3:2677-2682, 2013 and Probst et al., “Flow control of small objects on chip: Manipulating live cells, quantum dots, and nanowires,” IEEE Control Systems, 32(2):26-53, April 2012. The authors use linear models of the electrodes potentials, and the particles effect on the electric field distribution is negligible. However, the presented linearity in the electrodes potentials does not hold when driving forces are primarily dielectrophoretic, thus limiting the applicability of these techniques. Further, the presented linearity may not hold with objects on a micro-scale.

Further, Zeminek et al., ‘Feedback-controlled dielectrophoretic micromanipulation,” 2018 International Conference on Manipulation, Automation and Robotics at Small Scales (MARSS), July 2018, describe a dielectrophoresis-based feedback for micro-sphere manipulation. The authors use a simulated annealing approach for solving the optimal control problem, where they take advantage of a sphere-like shape of the particle when building the system model. However, due to the dependence of this technique on the spherical shape of the particle being moved, limits the applicability of the technique.

Control algorithms that act on individual particles and that address many of the challenges described above have been described by Chow et al., “Micro-object assembly with an optically addressed array,” 2017 19th International Conference on Solid-State Sensors, Actuators and Microsystems (TRANSDUCERS), pages 682-685, June 2017; Matei et al., “Micro-scale chiplets position control,” Journal of Microelectromechanical Systems, 28(4):643-655, August 2019; Matei et al., “Towards printing as an electronics manufacturing method: Micro-scale chiplet position control,” 2017American Control Conference (ACC), pages 1549-1555, May 2017; and on Matei et al., “Micro-scale 2d chiplet position control: a formal approach to policy design.” 2020 59th IEEE Conference on Decision and Control (CDC), pages 5519-5524, 2020 the disclosures of which are incorporated by reference, address many of the inadequacies of other techniques described above and provide a control algorithms that act on individual particles. However, controlling and tracking a large number of micro-object-sized particles, at an individual level is computationally expensive. A much more computationally advantageous technique is to control simultaneously large number of particles and shape them into a desired density.

At a conceptual level, the objective of controlling can be represented as follows: starting with an initial micro-object-size particle density, such a uniform particle distribution, the particles need to converge to a target particle density (such as multivariate Gaussian distribution), over some time horizon, by varying the electrode potentials. There is a close connection between this objective and the optimal control of the Liouville equation. Controllability of the Liouville equation together with optimal control of its moments for some special cases (such as linear case) are discussed by Roger Brockett, “Notes on the Control of the Liouville Equation,” pages 101-129, Springer Berlin Heidelberg, Berlin, Heidelberg, 2012. An analysis of problems of optimal control of ensembles governed by the Liouville equation is also done in Bartsch et al., “A theoretical investigation of Brockett's ensemble optimal control problems,” Calculus of Variations and Partial Differential Equations, 2019, where the results apply to particular classes of problems (such as Liouville equation with unbounded drift function with linear and bilinear control mechanisms), and classes of cost functionals. In Efstathios Bakolas, “Dynamic output feedback control of the Liouville equation for discrete-time siso linear systems,” IEEE Transactions on Automatic Control, 64(10):4268-4275, 2019,” the authors introduce a dynamic output feedback control of the Liouville equations, applied to SISO discrete-time linear systems. Optimal control of the Liouville equation is part of a larger class control problems having partial differential equations (PDE) as dynamical constraints. The type of PDE typically determines the methods for solving their related analysis and synthesis problems. For parabolic PDE systems, their dominant dynamics can be characterized by finite-dimensional, ordinary differential equation (ODE) systems, generated through Galerkin projection, for example. The control approach in the case of such parabolic PDE systems is based on using ordinary differential equations (ODE) for controller design as described in Efstathios Bakolas, “Dynamic output feedback control of the liouville equation for discrete-time siso linear systems,” IEEE Transactions on Automatic Control, 64(10):4268-4275, 2019 and Dubljevicet al., “Distributed nonlinear control of diffusion-reaction processes,” In Proceedings of the 2003 American Control Conference, 2003, volume 2, pages 1341-1348, 2003. In the case of hyperbolic PDE systems, an infinite number of modes are needed to represent their dynamics. As a consequence, control schemes are designed by taking into account the spatial dimension, as described by I. Aksikas et al., “Brief paper: LQ control design of a class of hyperbolic pde systems: Application to fixed-bed reactor.” Automatica, 45(6):1542-1548, June 2009; Choi et al. “Model predictive control of cocurrent first order hyperbolic pde systems,” Industrial & Engineering Chemistry Research, 44(6):1812-1822, 2005; and Shang et al., “Feedback control of hyperbolic pde systems,” IFAC Proceedings Volumes, 33(10):533-538, 2000. IFAC Symposium on Advanced Control of Chemical Processes 2000, Pisa, Italy, 14-16 Jun. 2000. Another control application under PDE dynamical constraints is traffic control. For example, linearized versions of the Aw-Rascle-Zhang PDE model can be used to determine an output feedback control law that can be applied to traffic control, as described in Yu et al., “Output-Feedback PDE Control of Traffic Flow on Cascaded Freeway Segments.” In IFAC World Congress, Berlin, Germany, July 2020.

While controlling micro-object density distribution through solving an optimal control problem in terms of the Liouville equation is feasible, such an approach is numerically complex and thus computationally inefficient, greatly limiting the scalability of such approach. The complexity stems from the need to generate a discrete representation for the Liouville PDE, either through a finite elements approach or using spectral methods.

Therefore, there is a need for an easily scalable way to control density distributions of micro-objects and nano-objects of varying shapes.

### SUMMARY

System and method that allow to control density distributions of multiple particles (micro-or-nano-sized objects) to desired positions are described. A particle-based approach to approximate the particle density is used. In particular, a kernel density estimation (KDE) is used as a proxy for the initial particle density distribution and an optimal control problem is defined and solved using this approximation. The objective is to compute a sequence of electrode electric potentials so that the initial particle distribution is shaped into a target distribution after applying this sequence over time. The optimal control cost function is defined in terms of an L2 metric, with the L2 function that is used to compute the error between the particle density at the end of a time horizon and a target density. The KDE depends on the predicted trajectories of a set of particles, where the trajectory of a single particle is determined by a lumped, 2D, capacitive-based, nonlinear model describing the particle's motion. The particles are assumed to not interact with each other, and their motion is assumed to be completely determined by the electric field generated by the array of electrodes. The electric field induces an accumulation of potential energy at the particles. Automatic differentiation (AD) enabled by JAX is to compute the forces (such as the gradient of the potential energy) that act on the particles, and the gradients of the loss and constraint functions that are passed to the optimization algorithm.

In one embodiment, a system and method for micro-object density distribution control with the aid of a digital computer are provided. One or more parameters of a system for positioning a plurality of micro-objects are obtained by one or more processors configured to execute code, the system including a plurality of electrodes, the electrodes configured to induce a movement of the micro-objects when the micro-objects are suspended in a fluid proximate to the electrodes upon a generation of one or more electric potentials by one or more of the electrodes. A model describing a change of positions of the micro-objects due to capacitance-based interactions of the micro-objects with the electrodes is defined by one or more of the processors using the parameters. A density distribution of the micro-objects is estimated by one or more of the processors using kernel density estimation and at least one sensor. A target density distribution of the micro-objects is obtained by one or more of the processors. An optimal control problem is solved by one or more of the processors to derive based on the model, the target density distribution, and the estimated density distribution a sequence of the electric potentials for moving at least some of the micro-objects to minimize an error between the estimated density distribution and the target density distribution. At least some of the electrodes are actuated by one or more of the processors to generate the sequence of the electric potentials, wherein at least some of the micro-objects are moved upon the generation of the electric potentials.

Still other embodiments of the present invention will become readily apparent to those skilled in the art from the following detailed description, wherein is described embodiments of the invention by way of illustrating the best mode contemplated for carrying out the invention. As will be realized, the invention is capable of other and different embodiments and its several details are capable of modifications in various obvious respects, all without departing from the spirit and the scope of the present invention. Accordingly, the drawings and detailed description are to be regarded as illustrative in nature and not as restrictive.

### BRIEF DESCRIPTION OF THE DRAWINGS

FIG. 1 is a block diagram showing a system for micro-object density distribution control with the aid of a digital computer.

FIG. 2 is a diagram illustrating interactions between the video projector and the photo-transistor array of FIG. 1 in accordance with one embodiment.

FIG. 3 is a diagram illustrating the goal of the operation of the system via production of a target (“desired”) density distribution from an initial density distribution in accordance with one embodiment.

FIG. 4 is diagram illustrating capacitive-based interactions between one chiplet and five electrodes of the system of FIG. 1 situated at positions y, in accordance with one embodiment.

FIG. 5 is a diagram showing the COMSOL model of two conductors (spherical chiplet and an electrode) for capacitance computation in accordance with one embodiment.

FIG. 6 is a depiction of C(ξ), the capacitance between a particle and the electrode as a function of the particle horizontal position, where the numerical values were fitted on the error function parameterization.

FIG. 7 is a diagram illustrating the two-dimensional (2D) capacitance function determined from the one-dimensional model using the symmetry property.

FIG. 8 is a flow diagram showing a method for micro-object density distribution control with the aid of a digital computer in accordance with one embodiment.

FIG. 9 is a flow diagram showing a routine for modeling chiplet motion based on capacitance for use in the method of FIG. 8 in accordance to one embodiment.

FIG. 10 is a diagram showing, for purposes of illustration, initial positions of a plurality of particles.

FIG. 11 is a diagram, showing for purposes of illustration, positions of the particles of FIG. 10 after 4.95 seconds.

FIG. 12 is a diagram depicting a comparison between the target density and the KDE computed using the particle positions, at the end of the time horizon.

FIGS. 13A-13D are diagrams showing the electric potential changes over the time horizon, for four time samples.

### DETAILED DESCRIPTION

The system and method described below use a particle based approach, the particle density is approximately represented using a Kernel Density Estimation (KDE) that uses particle trajectories in the representation. The KDE is a proxy for the true particle density that can be evaluated using a subset of particles. The trajectory model of each particle is determined by a capacitive-based lumped model that reflects the potential energy accumulated at a particle as a result of applying an electric potential at the electrodes. The gradient of this potential energy is the force that acts on the particle. The control objective is to shape the particle density into a desired density over a finite time horizon. The loss function to be minimized is defined as the L2-norm between the KDE and the desired density, at the end of the time horizon. The optimization problem has as constraints the particle trajectories used by the KDE model. The trajectories of the particles are tracked via module that uses images captured by a high speed camera and object detection algorithms to identify particle positions. The particle positions that can be identified with low uncertainty are used by the KDE.

Control policies that allow to shape density distributions of multiple micro- and nano-objects are described below. While the description below focuses on micro-objects, the description is also applicable to nano-objects (objects on a nano-scale In the description below, such objects (micro or nano) can be referred to as “particles” or “chiplets.” The KDE is used as a proxy for the initial particle density distribution and an optimal control problem is defined and solved using this approximation. The optimal control cost function is defined in terms of an L2 metric (also referred to as the L2 norm or L2 function), with the L2 function that is used to compute the error between the particle density at the end of a time horizon and a target density. While some authors, such as Devroye et al., “A Probabilistic Theory of Pattern Recognition,” volume 31 of Stochastic Modelling and Applied Probability. Springer, 1996, make a strong case for using an L1 metric to compute the error because an L1 metric is transformation invariant. However, an L1 metric is more difficult to deal with from a numerical optimization perspective. Another possible loss function is the Kullback-Leibler loss, but such a function is not the best choice for non-parametric densities because the function is completely dominated by the tails of the densities. Accordingly, the use of the L2 metric used as the optimal control function is superior to the alternatives.

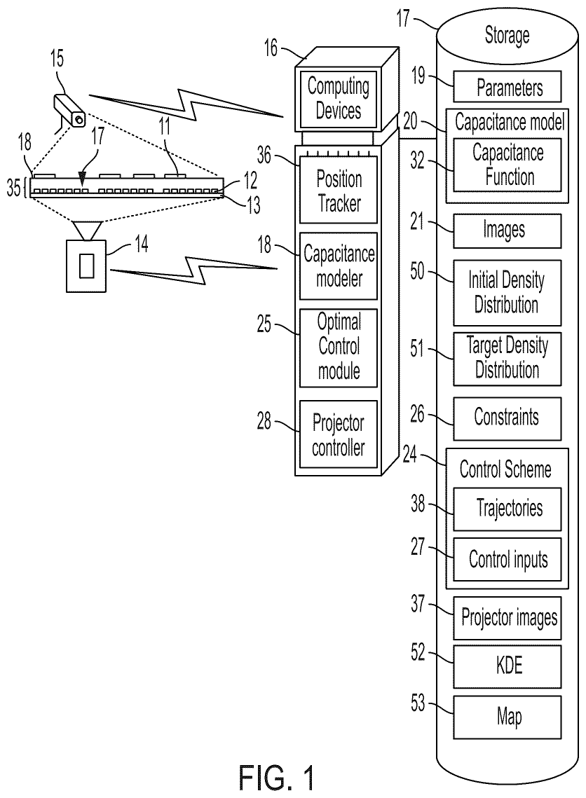

FIG. 1 is a block diagram showing a system 10 for micro-object density distribution control with the aid of a digital computer. The system 10 allows for coordinated assembly involving multiple objects 11, such as micro-objects or nano-objects. The size of the objects 11 vary between being on the nano scale (<1 μm), and micro-scale (as much as 100s of μm), though other sizes are possible. The objects 11 can be spherical, though other shapes are also possible, such as a rectangular shape, though still other shapes are also possible. In one embodiment, the diameter of the sperical objects 11 can be 20 μm to 50 μm, though other diameters are also possible. In one embodiment, the dimension of the rectangular objects 11 can be 200 μm×300 μm×100 μm, though other dimensions are also possible. The objects 11 are immersed in a dielectric fluid 17 contained within an enclosure 18, with a layer of film (not shown) being below the dielectric fluid 17 contained within the enclosure 18. In one embodiment, the dielectric fluid 17 is Isopar® M, manufactured by ExxonMobil Chemical Company of Spring, Texas, though other dielectric fluids 17 are also possible. The dielectric fluid 17 can include one or more additives, such as with di-2-ethylhexylsulfosuccinate (AOT) charge director molecules, though other additives are also possible. The objects 11 can be made out of aluminium oxide (AlOx), though other materials are possible. In the description below, the objects 11 are referred to as chiplets 11, though other ways to name the objects 11 are possible. In one embodiment, the film can be a 50 μm thick perfluroalkoxy (PFA) film, though other kinds of film of other thicknesses are possible.

Below the suspended chiplets 11 are a plurality of electrodes 12 forming an array 35, the electrodes configured to generate a dynamic potential energy landscape for manipulating objects with dielectrophoretic (“DEP”). The film is laminated on the electrodes 12. In one embodiment, the electrodes can be square shapes and made off copper, though other shapes and materials are also possible. In one embodiment, the dimensions of a square electrode 12 can be a 16 μm width and 100 nm thickness, though other dimensions are also possible in a further embodiment. The array 35 can include multiple rows of the electrodes 12, with each row including multiple electrodes 12.

The electric potentials generated by the electrodes 12 are controlled by array 13 of photo-transistors, the array including an active-matrix photo-transistor backplane that is set on glass. The multiple photo-transistors on the backplane form the array 13, with each of the photo-transistors in the array 13 being in control of the electric potentials generated by a single electrode 12. In particular, each of the photo-transistors in the array 13 is attached to one electrode 12. The array 13 of phototransistors can have additional characteristics, such as those described in Rupp et al., “Chiplet micro-assembly printer,” 2019 IEEE 69th Electronic Components and Technology Conference (ECTC), pages 1312-1315, May 2019, the disclosure of which is incorporated by reference.

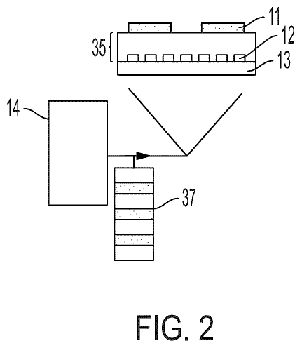

The array 13 is optically addressed by a video projector 14 to enable dynamic control of the electrostatic energy potential and manipulation of the positions of multiple chiplets 11 at the same time. In particular, the video projector 14 is used to address each photo-transistor controlled electrode 12, as illustrated by FIG. 2, allowing for facile zoom factor changes and stitching into larger arrays. FIG. 2 is a diagram illustrating interactions between the video projector 14 and the photo-transistor array 13 of FIG. 1 in accordance with one embodiment. The video projector 14 actuates the electrodes 12 by projecting pre-defined patterns: images 37 that are generated based on control inputs: the electric potentials to be generated by the electrodes to achieve desired motion of the chiplets 11, as further described below. The pixelated light projected by the projector 14 that makes up the images charges each individual phototransistor 13 in the array to the degree necessary so that the electrode 12 charged by that phototransistor produces the desired electric potential. Additional details regarding the photo-transistor array 13 can be found in commonly-owned U.S. Patent Application Publication No. 20220156881, published May 19, 2022, the disclosure of which is incorporated by reference.

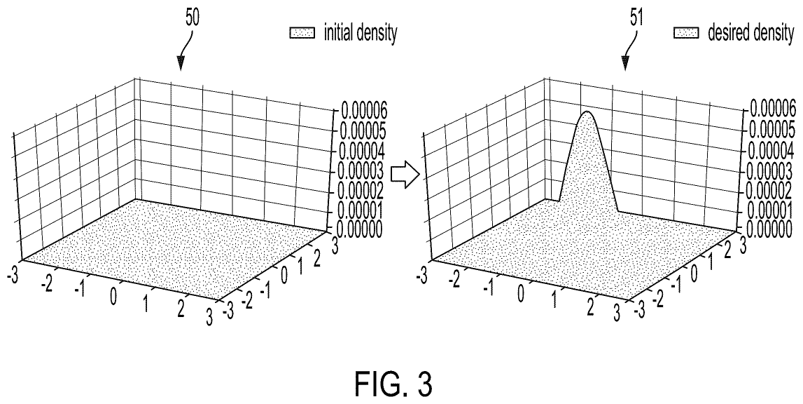

Returning to FIG. 1, the system 10 further includes a high speed camera 15 that tracks locations of the chiplets 11 being moved. Both the video projector 14 and the camera 15 are interfaced to one or more computing devices 20, which can control the electrodes 12 through the projector 14 to induce a formation of a target chiplet density distribution from an initial chiplet density distribution. FIG. 3 is a diagram illustrating the goal of the operation of the system 10 via production of a target (“desired”) density distribution 51 from an initial density distribution 50 in accordance with one embodiment.

Returning to FIG. 1, the connections between the one or more computing devices 16 can be direct, such as a via wires or a wireless connection to physically proximate one or more computing devices 16, or the connection can be via an Internetwork to physically remote one or more computing devices 16, such as via the Internet or a cellular network. The one or more computing devices 16 can include a plurality of computer processors that are specialized to perform data processing in parallel. In one embodiment, the computer processors can be graphics processing unit (GPU). In a further embodiment, the computer processors can be tensor processing units (TPUs), developed by Google, LLC of Mountain View, California, which are particularly specialized for neural network machine learning. In a still further embodiment, the computer processors can include both GPUs and TPUs. In a still further embodiment, the computer processors can include other types of processors specialized for parallel processing.

While the one or more computing devices 16 are shown as a server, other types of computer devices are possible. The computing devices 16 can include one or more modules for carrying out the embodiments disclosed herein. The modules can be implemented as a computer program or procedure written as source code in a conventional programming language and is presented for execution by the processors as object or byte code. Alternatively, the modules could also be implemented in hardware, either as integrated circuitry or burned into read-only memory components, and each of the computing devices 16 can act as a specialized computer. For instance, when the modules are implemented as hardware, that particular hardware is specialized to perform the computations and communication described above and other computers cannot be used. Additionally, when the modules are burned into read-only memory components, the computer storing the read-only memory becomes specialized to perform the operations described above that other computers cannot. The various implementations of the source code and object and byte codes can be held on a computer-readable storage medium, such as a floppy disk, hard drive, digital video disk (DVD), random access memory (RAM), read-only memory (ROM) and similar storage mediums. Other types of modules and module functions are possible, as well as other physical hardware components. For example, the computing device 16 can include other components found in programmable computing devices, such as input/output ports, network interfaces, and non-volatile storage, although other components are possible. In the embodiment where the computing devices 16 are servers, the server can also be cloud-based or be dedicated servers.

The one or more computing devices 16 are interfaced to a storage 17 and execute a capacity modeler 18 that obtains parameters 19 of the system 10, stores the parameters 19 in the storage 17, and models capacitance between the electrodes 12 and the chiplets 11. For the modeling described below, the one or more computing devices proceed on the assumption that the chiplets 11 do not interact with each other. The parameters 19 can include the diameter of the chiplets 11, the dimensions of the electrodes 12, the dielectric fluid constant (e.g. as ε=2), the fixed positions of the electrodes 12, material of the chiplets 11 and electrodes 12, and the vertical distance between the chiplets 11 and the electrodes 12 (“height” of the chiplets 11). Other parameters 19 are still possible.

The capacity modeler 18 creates a 2D model 20 for the motion of a single chiplets 11 under the effect of the potential field induced by the electrodes 12 in the array. The description of the model 20 follows below. In the description, scalars, vectors and random variables are denoted by Italic symbols, bold Italic symbols, and capital Italic symbols, respectively. Let ƒ(x) be a multi-variable map, where x=(xᵢ) is a vector of scalars. The gradient of ƒ is denoted by ∇ƒ(x), and the partial derivative of ƒ, with respect to xᵢ is denoted by by

$$\frac{\partial f}{\partial {x}_{i}} ( x ) .$$

For a vector valued function F(x),

$$\frac{\partial F}{\partial x}$$

denotes the Jacobian of F. For a function ƒ(x), with x=(x₁, x₂), ƒ(x₁,x₂) is an equivalent notation. The divergence operator applied to a vector-valued function F(x) is denoted by ∇·F. For a matrix A, |A| denotes its determinant. The gradients can be computed using automatic differentiation implemented by JAX, such as described by James Bradbury et al. JAX: composable transformations of Python+NumPy programs, 2018, the disclosure of which is incorporated by reference, though other techniques to compute the gradients are possible. For example, other platforms such as Pytorch distributed by Meta AI can be used for gradient calculation.

The model 20 is for one particle 11 only and neglects possible interactions when particles get close to each other. Through application of electric potentials to the electrodes 12, DEP forces that act on the particles 11 are generated. A viscous drag force proportional to the velocity (the drag force is proportional to the velocity in non-turbulent flows, that is, when the Reynolds number is small) opposes the particle's 11 motion. Due to the negligible mass of the particle 11, the acceleration can be neglected. Thus the particle dynamical model 20 can be described by:

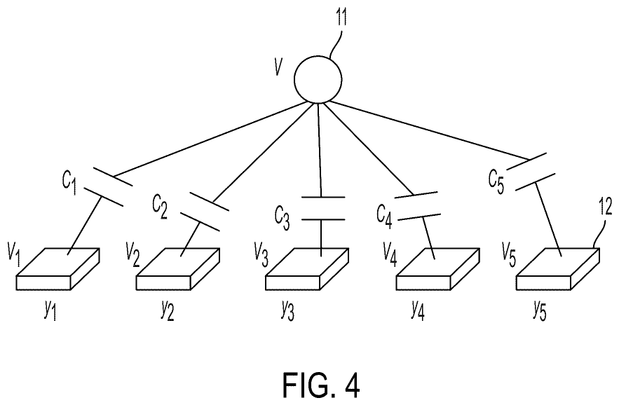

μ\dot{x}=F(x,V), (1)

where x denotes the 2D particle position measured at its center of mass, V=(V_{i,j}) are the electrode electric potentials, μ is the fluid dependent viscous coefficient, and F(x,V) is the vector of forces acting on the particle. The indices (i,j) are associated to 2D electrode positions y_{i,j}. The forces F(x,V) are expressed as a function of the potential energy of the particle. The potential energy is computed using a capacitive-based electrical circuit that lumps the interaction between the electrodes 12 and the particle 11. Such a circuit is shown in FIG. 4, where only one row with five electrodes of the array is depicted. FIG. 4 is diagram illustrating capacitive-based interactions between one chiplet and five electrodes 12 of the system of FIG. 1 situated at positions y, in accordance with one embodiment.

The particle 11 and the electrodes 12 act as metal plates; hence the capacitances of these capacitors are dependent on the particle 11 position. As expected, the maximum values are attained when the particle's 11 position maximizes the overlap with the electrodes 12. For simplification, the analysis is limited to low frequency region only, where the dielectric constant is not frequency dependent. The vector of forces F can be formally expressed as F(x,V)=∇U(x,V), where U(x,V) is the potential energy of the particle, given by:

U(x,V)=½Σ_{i,j=1}^{N}C^{i,j}(x)[V_{i,j}−v(x,V)]², (2)

where C_{i,j}(x) is the capacitance between the particle at position x and electrode (i,j), V_{i,j} is the electric potential of electrode (i,j), v(x) is the electric potential of the particle, and N is the number of actuated electrodes. If there are electrophoretic effects on the particle, the potential energy can be readily extended to include such effects. The capacitance modeler 18 computes the particle potential in terms of the electrode potentials, by solving for the voltages and currents in the electrical circuit shown in FIG. 4. In particular, the steady state particle potential is given by

$$v ( x , V ) = \frac{1}{{\sum }_{i , j = 1}^{N} {c}_{i , j} ( x )} {\sum }_{i , j = 1}^{N} {C}_{i , j} ( x ) {V}_{i , j} . \qquad ( 3 )$$

Feedback control design requires explicit expressions for the capacitances between the particle 11 and electrodes 12. The capacitance modeler 18 creates the model 20 using high fidelity simulations using the COMSOL Multiphysics® software developed by COMSOL, Inc. of Burlington, MA (“COMSOL”), though other kinds of simulations using other kinds of software are also possible. An example how the capacitances can be learned is described below. This process can be repeated for other types of particles, geometries and material properties. For symmetric particles 11 (such as beads, though other symmetric particles are possible), the capacitances by simulating a 2D electrostatic COMSOL model. This implies that the capacitance function is of the form C_{i,j}(x)=C(∥x−y_{i,j}∥), where x=(x₁,x₂) denotes the particle 2D position, and y_{i,j} is the fixed position of electrode i,j

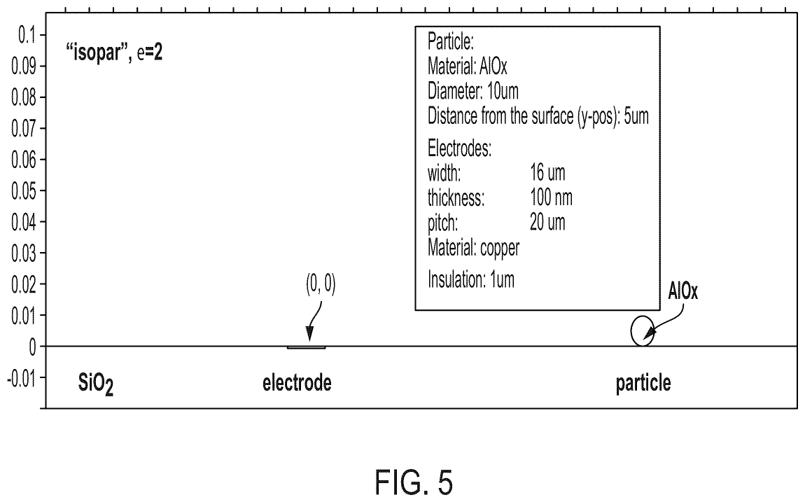

FIG. 5 is a diagram showing the COMSOL model of two conductors (spherical chiplet 11 and an electrode 12) for capacitance computation in accordance with one embodiment. The electrode's 12 position is (0,0). As shown with reference to FIG. 5, in the COMSOL model, a 16 μm width and 100 nm thickness copper plate, and a 10 μm diameter, aluminum oxide (AlOx) spherical object are surrounded by a dielectric with the same properties as the Isopar-M solution. The quasi-static models are computed in a form of electromagnetic simulations using partial differential equations, where the capacity modeler 18 uses ground boundary (zero potential) as the boundary condition. The capacitance matrix entries are computed from the charges that result on each conductor when an electric potential is applied to one of them and the other is set to ground. The COMSOL electrostatic model used the following parameters 19: the diameter of the chiplets 11, the electrode 12 dimensions, the dielectric fluid constant (ε=2) and the positions and material of the sphere and electrode. The chiplet 11 height is set at (z=5 μm) and the chiplet position on the x-axis is varied over the interval [−1 mm, 1 mm], though in a further embodiment, other positions are possible. Due to the size of the chiplet 11 versus the size of the electrodes 12, fringe effects (electric field distortions at the edges) are significant. The simulation results generate capacitances between the electrode 12 and the particle 11 for all considered positions. The capacitance function is parameterized using error functions

$$C ( ξ ) = {\sum }_{i = 1}^{m} {a}_{i} [ Φ ( \frac{ξ + δ}{{c}_{i}} ) - Φ ( \frac{ξ - δ}{{c}_{i}} ) ] ,$$

where

$$Φ ( ξ ) = \frac{1}{\sqrt{π}} {\int }_{- ξ}^{ξ} {e}^{- {t}^{2}} dt$$

is the error function, ξ is the distance between the center of the particle and the electrode center assumed at the origin, aᵢ and cᵢ>0 are scalars, and δ is half of the electrode pitch (10 μm in one embodiment).

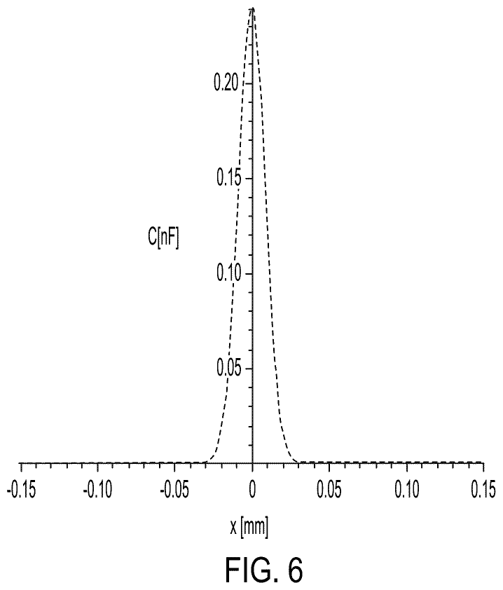

FIG. 6 is a depiction of C(ξ), the capacitance between a particle 11 and an electrode 12 as a function of the particle horizontal position, where the numerical values were fitted on the error function parameterization. For symmetric particles 11 (such as spherical particles), the 1D model to a 2D model using the transformation ξ→\sqrt{x₁²+x₂²}, which results in a capacitance function 32

$$C ( {x}_{1} , {x}_{2} ) = {\sum }_{i = 1}^{m} {a}_{i} [ Φ ( \frac{\sqrt{{x}_{1}^{2} + {x}_{2}^{2}} + δ}{{c}_{i}} ) - Φ ( \frac{\sqrt{{x}_{1}^{2} + {x}_{2}^{2}} - δ}{{c}_{i}} ) ] .$$

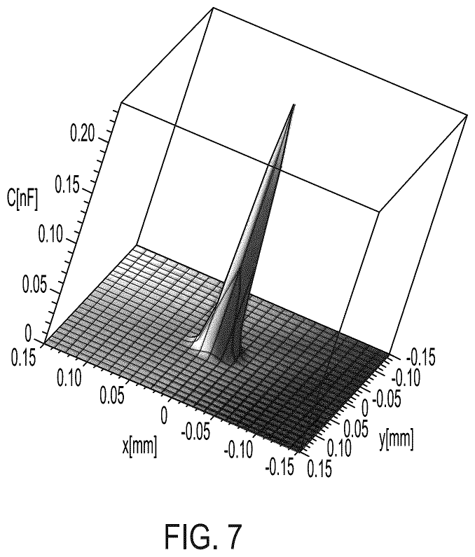

For the spherical particle 11, consideration of only one term in the parameterization of the capacitance function is enough, and the resulting 2D shape is depicted in FIG. 7. FIG. 7 is a diagram illustrating the two-dimensional (2D) capacitance function 32 determined from the one-dimensional model using the symmetry property.

The capacity modeler 18 further transforms the particle motion model 20 from a discretized axtuation mechanism (discrete set of electrodes) to a continuous one. The description below starts with the 1D case. The particle 11 electric potential is represented as

$$v ( x , V ) = \frac{1}{{\sum }_{i = 1}^{N} {C}_{i} ( x )} {\sum }_{i = 1}^{N} {C}_{i} ( x ) {V}_{i} ,$$

and interpret v(x,V) as the expected value of a random function [symbol] (Y)|X=x over a discrete distribution pᵢ(x)=Cᵢ(x)/Σᵢ₌₁^{N}Cᵢ(x). The probability mass function pᵢ(x) is represented as a conditional probability pᵢ(x)=Pr(Y=yᵢ|X=x), and hence the particle potential can be expressed as v(x)=E[ [symbol] (Y)|X=x], where Vᵢ= [symbol] (y₁) is a function that reflects the electric potential at each point yᵢ. The discrete probability distribution can be seen as a discretization of a continuous probability distribution, i.e., pᵢ(x)=∫_{y}_{ᵢ}_{-δ}^{y}^{ᵢ}^{+δ}ƒ(y|x)dy, where δ is half of the electrode pitch. The parameterization of the capacitance function in terms of the error functions shows that the conditional probability density function (p.d.f.) is a mixture of Gaussian functions. For a sphere shaped particle, the mixture has only one term, and hence the capacitance is expressed as

$${C}_{i} ( x ) = a [ Φ ( \frac{x - {y}_{i} + δ}{c} ) - Φ ( \frac{x - {y}_{i} - δ}{c} ) ] = 2 a {\int }_{{y}_{i} - δ}^{{y}_{i} + δ} f ( y \vert x ) dy ,$$

where

$$f ( y \vert x ) = \frac{1}{\sqrt{2 π {σ}^{2}}} {e}^{- \frac{{( y - x )}^{2}}{2 {σ}^{2}}} ,$$

with

$$σ = \frac{c}{\sqrt{2}} .$$

Therefore, the particle potential in the continuous representation can be expressed as v̅(x)=E[ [symbol] (Y)|X=x], where the expectation is computed with respect to the conditional Gaussian distribution, [symbol] (x,σ), and [symbol] (Y) is a function that assigns an electric potential to each point y. The potential energy can now be represented as U(x)=aE[( [symbol] (Y)−\dot{v}(X))²|X=x], and the 1D particle dynamics is given by the following partial differential equation:

$$μ \dot{x} = \frac{\partial U ( x )}{\partial x} , \qquad ( 4 )$$

where U(x)=aE[( [symbol] (Y)−v̅(X))²|X=x], and v̅(x)=E[V(Y)|X=x].

Extension to 2D case: the particle position is denoted by x=(x₁, x₂) and the position of electrode (i,j) is denoted by y_{i,j}(y₁^{i,j}, y₂^{i,j}). The particle dynamics becomes

μ\dot{x}=∇U(x,V), (5)

where μ is the viscous coefficient, and U(x,V) denotes the particle's 11 potential energy. As is the 1D case, the potential energy is given by:

$$U ( x , V ) = \frac{1}{2} {\sum }_{i , j = 1}^{N} {{C}_{i , j} ( x ) [ {V}_{i , j} - v ( x ) ]}^{2} ,$$

where v(x,V)denotes the particle electric potential, C_{i,j}(x)=C(∥x−y_{i,j}∥) represents the capacitance between the particle at the position x and electrode i,j at position y_{i,j}, and V_{i,j} represents the potential of electrode (i,j). Similar to the 1D case, the capacitance C_{i,j} can be represented as the un-normalized discretization of a multivariable Gaussian p.d.f, that is:

$${C}_{i , j} ( x ) = 4 a {\int }_{{y}_{1}^{i , j} - δ / 2}^{{y}_{1}^{i , j} + δ / 2} {\int }_{{y}_{2}^{i , j} - δ / 2}^{{y}_{2}^{i , j} + δ / 2} f ( y \vert x ) dy , \qquad ( 6 )$$

where the conditional density function ƒ(y|x) is the multivariate Gaussian distribution [symbol] (X,σ²I). The potential energy is similar to the 1D case and is given by U(x)=aE[( [symbol] (Y)−v̅(X))²|X=x], where [symbol] (y) is a map such that [symbol] (y_{i,j})=V_{i,j}.

Using a mean-field approximation argument (see for instance Carrillo et al. “Particle, kinetic, and hydrodynamic models of swarming,” pages 297-336, Birkhauser Boston, Boston, 2010 in the context of the Cucker-Smale model), the Liouville equation that describes the evolution of the density of a large number of particles can be derived. A control input dependent PDE of the form is obtained:

$$∇ \cdot [ f ( x , t ) F ( x , V ( t ) ) ] + \frac{\partial f ( x , t )}{\partial f} = 0 , \qquad ( 7 )$$

where ƒ(x,t) denotes the particle density, and V(t) are the control inputs (i.e., the electrode potentials).

The one or more computing devices further execute an optimal control module 25 that solves an optimal control problem whose solution provides a control scheme 24 for changing the initial density distribution 50 to the target density distribution 51. The optimal control problem is defined to shape an initial density function ƒ₀(x)=ƒ(x,0) into a target density function ƒ_{d}(x)). The ideal optimal control problem can be phrased as follows: given a finite time horizon [0,T], find the electric potentials V(t)=(V_{i,j}(t)) for t∈[0,T] such that ƒ(x,T) equals the target density ƒ_{d}(x). The main constraint of the optimization problem are the dynamics of the particle motion. The loss function to be minimized is defined as the L2-norm between the KDE and the desired density, at the end of the time horizon. The optimization problem has as constraints the particle trajectories used by the KDE model. The trajectories of the particles are tracked via module that uses images captured by a high speed camera and object detection algorithms to identify particle positions. The particle positions that can be identified with low uncertainty are used by the KDE. KDE 52 is used as a proxy for the initial (before particle density distribution ƒ(x,T). Let {{x⁽ⁱ⁾}ᵢ₌₁ⁿ be a set of n particles. Then the KDE is given by

$${\hat{f}}_{H} ( x , t ) = \frac{1}{n} {\sum }_{i = 1}^{n} {K}_{H} ( x - {x}_{i} ) ,$$

where H∈R² is the symmetric, positive definite bandwidth matrix, K_{H}(x)=|H|^{-1/2}K(H^{-1/2}x), with K being the kernel function. Examples of commonly used kernels include: boxcar, Gaussian, Epanechnikov or tricube, though other kernels are also possible. In one embodiment, the standard multivariate kernel is used for KDE 52 determination:

$${K}_{H} = \frac{1}{\sqrt{{( 2 π )}^{2} \vert H \vert}} {e}^{- \frac{1}{2} {x}^{T} H x} ,$$

due to the kernel's smoothness.

Let [symbol] ∈R² be a compact set that bounds the particle positions, and let Vmax be the maximum magnitude of the electric potentials. The following optimal control problem, identified by numeral (8), is then formulated:

$${min}_{V ( t ) , {x}^{( i )} ( t ) , t ∈ [ 0 , T ]} {\int }_{} {( {\hat{f}}_{H} ( x , T ) - {f}_{d} ( x ) )}^{2} dx$$

$$s . t . : {\dot{x}}^{( i )} = F ( {x}^{( i )} , V ( t ) ) , {x}^{( i )} ( 0 ) = {x}_{0}^{( i )}$$

$$\hat{f} ( x , T ) = \frac{1}{n} {\sum }_{i = 1}^{n} {K}_{H} ( x - {x}^{( i )} ( T ) ) ,$$

$$\vert V ( t ) \vert \leq {V}_{max} , ∀ t ∈ [ 0 , T ] ,$$

$${x}^{( i )} ( t ) ∈ , ∀ t ∈ [ 0 , T ] ,$$

where x₀⁽ⁱ⁾ are the initial particle positions.

To convert the optimal control problem (8) into a format amenable to numerical optimization, optimal control module 25 needs to discretize both the time and space and generate approximations of the loss function and of the particle dynamics. For the spatial discretization, the module 25 can employ a uniform mesh with cells that are centered at (x_{i,j}), each cell having area Δx². In addition, the module 25 discretizes the time using a sampling period Δt, resulting in a sequence of samples {tₖ}. With these discretization schemes, and employing a trapezoidal rule to approximate the particle dynamics, the optimization problem above becomes as follows, as denoted by numeral (9):

The one remaining challenge is evaluation of the potential force F(x,V). As U(x)=aE[(V(Y)−v̅(X))²|X=x], where v̅(x)=E[V(Y)|X=x], with the expectations are computed over the distribution [symbol] (x,σ²I), with σ a parameter determined from the geometric properties of the spherical particle. Given the fixed positions of the electrodes y_{i,j}(y₁^{i,j},y₂^{i,j}), the average potential v̅(x) and the potential energy can be approximated by approximating the conditional Gaussian distribution with a probability mass function. Accordingly,

$${min}_{V ( t ) , {x}^{( i )} ( {t}_{k} )} {\sum }_{i , j} {( \hat{f} ( {x}_{i , j} , T ) - {f}_{d} ( {x}_{i , j} ) )}^{2}$$

$$s . t . : {x}_{{t}_{k + 1}}^{( i )} = {x}_{{t}_{k}}^{( i )} + \frac{Δ t}{2} [ F ( {x}^{( i )} ( {t}_{k + 1} ) , V ( {t}_{k + 1} ) ) + F ( {x}^{( i )} ( {t}_{k} ) , V ( {t}_{k} ) ) ] , {x}^{( i )} ( 0 ) = {x}_{0}^{( i )}$$

$$\hat{f} ( {x}_{i , j} , T ) = \frac{1}{h} {\sum }_{i = 1}^{n} {K}_{H} ( {x}_{i , j} - {x}^{( i )} ( T ) ) ,$$

$$\vert V ( {t}_{k} ) \vert \leq {V}_{max} , ∀ {t}_{k} ∈ [ 0 , T ] ,$$

$${x}^{( i )} ( {t}_{k} ) ∈ , ∀ {t}_{k} ∈ [ 0 , T ] ,$$

$$\overline{v} ( x ) \approx {\sum }_{i , j} {p}_{i , j} {V}_{i , j} ,$$

where p_{i,j} are, not surprisingly, the normalized 2D capacitances in equation (6) above. Similarly,

U(x)≈Σ_{i,j}p_{i,j}[V_{i,j}−v̅(x)]²

The challenge with this approach is that the accuracy of the approximation depends on the granularity of the electrode array 35: the more electrodes 12 are in the array 35, the better the approximations are. The module 25 can circumvent this dependency by looking at the electrode potentials as a continuum rather than discrete points. In such a case, the discrete electric potentials become evaluations of a continuous map of potentials [symbol] (y,t), evaluated at discrete points, i.e., V_{i,j}(t)= [symbol] (y_{i,j},t). Thus, instead of the optimal control problem (9) to generate a set of discrete potentials over time, the module 25 can learn a continuous, parameterized map 53 (y,t;β), where β are the parameters of the map 53. The loss function to be minimized of the optimal control problem is defined as the L2-norm between the KDE and the desired density, at the end of the time horizon.

One additional consequence of learning a continuous map 53 is that the module 25 is no longer bound to use the discrete electrode positions when computing the potential energy U and the potential energy gradient. The module 25 has the options to use discretization schemes that offer a better accuracy when computing the expectations. In particular, the module 25 can make use of Gauss quadrature rules described by Gene H. Golub and John H. Welsch. “Calculation of gauss quadrature rules.” Technical report, Stanford, CA, USA, 1967, the disclosure of which is incorporated by reference, often found in the theory of generalized chaos polynomials (GPC) as described by Anthony O'Hagan, “Polynomial chaos: A tutorial and critique from a statistician's perspective.” Technical report, University of Sheffield, UK, May 2013; Ralph C. Smith, “Uncertainty Quantification: Theory, Implementation, and Applications.” Society for Industrial and Applied Mathematics, Philadelphia, PA, USA, 2013; Norbert Wiener, “The Homogeneous Chaos,” American Journal of Mathematics, 60(4):897-936, 1938; Xiu et al., “Performance evaluation of generalized polynomial chaos,” In Computational Science ICCS 2003: International Conference, Melbourne, Australia and St. Petersburg, Russia, Jun. 2-4, 2003 Proceedings, Part IV, pages 346-354, Berlin, Heidelberg, 2003. Springer Berlin Heidelberg, the disclosures of which are incorporated by reference. A particular case of Gauss quadrature rules that the model can use for computing expectations is Gauss-Hermite quadrature, which is a particular case of Gauss quadrature that is applied to a particular kind of function, i.e., a function that can be written as a product between a Gaussian function and some other function, as described by Gauss-Liu, Q., & Pierce, D. A. (1994). A Note on Gauss-Hermite Quadrature. Biometrika, 81(3), 624-629. https://doi.org/10.2307/2337136, the disclosure of which is incorporated by reference. Gauss quadrature rules provide the means to accurately evaluate the conditional expectations, using a small number of points. Since the conditional probability distribution of Y|X=x can be expressed as product of two Gaussian distributions Yᵢ|Xᵢ=xᵢ˜ [symbol] (xᵢ,σ²), with i∈{1,2}, the expectation of V(Y)|X=x is given by

$$\overline{v} ( x ) = E [ V ( Y ) \vert X = x ] \approx \frac{1}{π} {\sum }_{i , j = 1}^{n} {w}_{i} {w}_{j} V ( \sqrt{2} σ {y}_{i} + {x}_{1} , \sqrt{2} σ {y}_{j} + {x}_{2} ) , \qquad ( 10 )$$

where n is the number of sample points, yᵢ are the roots of the physicists' version of the Hermite polynomial Hₙ(y) and wᵢ are associated weights given by

$${w}_{i} = \frac{{2}^{n - 1} n ! \sqrt{π}}{{{n}^{2} [ {H}_{n - 1} ( {y}_{i} ) ]}^{2}} .$$

Similarly, the variance of V(Y)|X=x can be approximated as

$$U ( x ) = E [ {( V ( Y ) - \overline{v} ( X ) )}^{2} \vert X = x ] \approx \frac{1}{π} {\sum }_{i , j = 1}^{n} {w}_{i} {{w}_{j} [ V ( \sqrt{2} σ {y}_{i} + {x}_{1} , \sqrt{2} σ {y}_{j} + {x}_{2} ) - \overline{v} ( x ) ]}^{2} . \qquad ( 11 )$$

Accordingly, the optimal control formulation for learning a continuous map 53 of potentials over time can be formulated as follows, denoted by numeral (12):

$${min}_{β , {x}^{( i )} ( {t}_{k} )} {\sum }_{i , j} {( \hat{f} ( {x}_{i , j} , T ) - {f}_{d} ( {x}_{i , j} ) )}^{2}$$

$$s . t . : {x}_{{t}_{k + 1}}^{( i )} = {x}_{{t}_{k}}^{( i )} + \frac{Δ t}{2} [ F ( {x}^{( i )} ( {t}_{k + 1} ) , 𝒱 ( \cdot , {t}_{k + 1} ; β ) ) + F ( {x}^{( i )} ( {t}_{k} ) , 𝒱 ( \cdot , {t}_{k} ; β ) ) ] , {x}^{( i )} ( 0 ) = {x}_{0}^{( i )}$$

$$\hat{f} ( {x}_{i , j} , T ) = \frac{1}{n} {\sum }_{i = 1}^{n} {K}_{H} ( {x}_{i , j} - {x}^{( i )} ( T ) ) ,$$

$$\vert 𝒱 ( \cdot , {t}_{k + 1} ; β ) \vert \leq {V}_{max} , ∀ {t}_{k} ∈ [ 0 , T ] ,$$

$${x}^{( i )} ( {t}_{k} ) ∈ , ∀ {t}_{k} ∈ [ 0 , T ] .$$

The advantage of learning a control map 53 is that the module 25 can control the complexity of the optimization variables as the number of electrodes 12 increase. There remains the challenge of selecting a parameterization for [symbol] (x,t;β). The module 25 can take a global approach to the map 53 representation and get inspiration from spectral methods (such as described by Lloyd N. Trefethen, “Finite difference and spectral methods for ordinary and partial differential equations,” 1996) to represent the map [symbol] : [symbol] ×[0, T] in terms of a set of polynomial basis functions, namely:

[symbol]

(x,t)=Σ_{i,j=1}^{M}v_{i,j}(t)φ_{i,j}(x),

where M² is the number of terms in the approximation, and φ_{i,j}(x)=φᵢ(x₁)φᵢ(x₂), with {φᵢ} a set of polynomial basis functions (such as Chebyshev or Legendre polynomials, though other polynomial basis functions are also possible). In this case the parameters β are the coefficients v_{i,j}(tₖ) for all discrete time instances. Alternatively, the module 25 can use universal function approximators, such as neural networks (NNs) (as described by Kurt Hornik, Maxwell Stinchcombe, and Halbert White. Multilayer feedforward networks are universal approximators. Neural Networks, 2(5):359-366, 1989), and the parameters β are the weights and biases. This option has the advantage that β no longer depends directly on the number of time instances. Similar ideas can be used to represent the trajectory of the particles. For example, the module 25 can use NNs that take as input time and generate as output the particle position. Such approaches have already been used in the context of PDEs, where NNs are used to approximate PDE solutions, as described by Hornik et al., “Multilayer feedforward networks are universal approximators.” Neural Networks, 2(5):359-366, 1989. Unlike more traditional methods though (such as finite elements, (pseudo-)spectral methods), the effects of the approximation errors are much more difficult to quantify.

In one embodiment, the loss function in the optimal control formulation includes the KDE 53 for the particle density at the final time only. As the quality of the estimation depends on the choice of the bandwidth matrix H, at the final time, the module 25 can use the statistics of target density to select H. For example, using Silverman's rule (Scott's rule is identical for the 2D case), the module 25 can choose \sqrt{H}ᵢᵢ=n^{-1/5}σᵢ, and Hᵢⱼ=0, where σᵢ is the standard deviations for the i^{th} variable, and i,j∈{1,2}. As the module 25 selects the target density 51, atcan picked in relation with this density. If the module 25 needs intermediate particle densities, as the module 25 may not have good ways of estimating σᵢ, the module 25 may end up computing under or over smooth estimates.

The one or more computing devices 16 further execute a position tracker 36 that analyzes the images 21 of the chiplets 11 captured by the high-speed camera 15, with the results of the analysis being used in combination with the KDE 53 to determine the initial density distribution 50 of the chiplets. In particular, the images taken by the camera are used to estimate the positions of the particles, and the estimated positions are used as initial positions of the particle 11 trajectories that are used to express the KDE 53. The initial particle density 50 and the target particle density 51 are used are used to determine a control scheme 24: a sequence of the control inputs 27 (electric potentials) for moving the particles from the initial density distribution 50 to the target density distribution 51 along desired trajectories 38. As mentioned above, the trajectory model of each particle is determined by a capacitive-based lumped model that reflects the potential energy accumulated at a particle as a result of applying an electric potential at the electrodes.

The control scheme 24 generated by the optimal control module 25 are used by a projector controller 28 executed by the one or more computing devices 16 to map the control inputs 27 to the images 37 that are provided to the video projector 14, and which in turn projects the images 37 to the photo-transistors controlling the electrodes 11, thus actuating the movement of the chiplets 11. The mapping can be done as described in U.S. Patent Application Publication No. US20200207617, entitled “Micro-assembler system for manipulating micro-objects,” to Plochowietz et al., published Jul. 2, 2020, the disclosure of which is incorporated by reference, though other ways to perform the mapping are also possible.

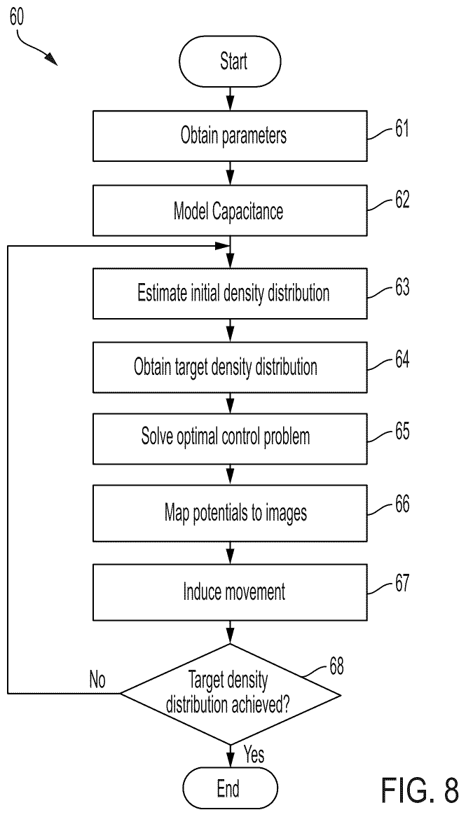

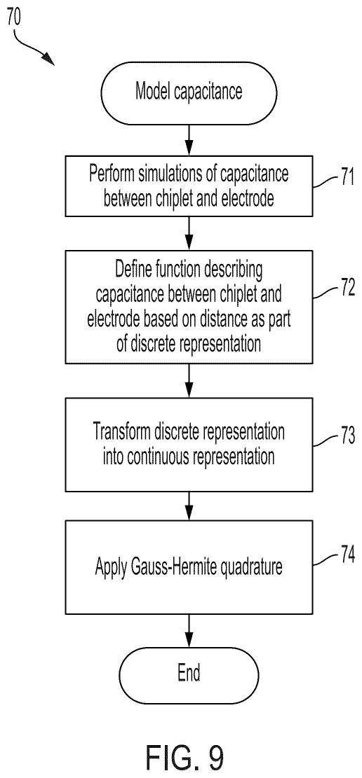

Using KDE to estimate an initial particle density distribution provides a computationally-efficient, scalable way to achieve desired positions of multiple micro-object-sized particles. FIG. 8 is a flow diagram showing a method 60 for micro-object density distribution control with the aid of a digital computer in accordance with one embodiment. The method 60 can be performed using the system of FIG. 1. Parameters of the system are obtained, such as diameter of the chiplets, the dimensions of the electrodes, the dielectric fluid constant, the initial positions and material of the chiplets and electrodes (which can be obtained using the high-speed camera), and the height of the chiplets, though other parameters are possible (step 61). A capacitance-based model of the motion of the chiplets is created (step 62), as described above with reference to FIG. 1 and as described below with reference to FIG. 9. An initial density distribution of the chiplets is obtained using at least one image obtained by the camera and KDE, as described above with reference to FIG. 1 (step 63). A target density distribution is obtained (step 64), such as being received from a user via a user interface of one of the computing device of system of FIG. 1, though other ways to obtain the target density distribution are also possible. An optimal control problem is solved to derive based on the motion model, the target density distribution, and the estimated density distribution a sequence of electric potentials for moving at least some of the micro-objects to minimize an error between the estimated density distribution and the target density distribution (step 65). The electric potentials are mapped to images for display by the video projector (step 66) and electrodes in the electrode array are controlled to induce the movement of the chiplets towards the desired density distribution (step 67). Positions of the chiplets are determined following the movement inducted by the electrodes using the high-speed camera as described above (step 68). If the chiplets have arrived achieved the target density distribution (step 68), the method 60 ends. If the chiplets still need to be moved to achieve the target density distribution (step 69), the method 60 returns to step 63.

The capacitance-based model of motion of the chiplets accounts ignores interactions that chiplets may have with each other. FIG. 9 is a flow diagram showing a routine 70 for modeling chiplet motion based on capacitance for use in the method 60 of FIG. 8 in accordance to one embodiment. Simulations, such as COMSOL simulations, are performed for capacitance between an electrode and a chiplet at multiple distances as described above with reference to FIG. 1 (step 71). A function describing the dependence between the capacitance between an electrode and a chiplet is defined based on the simulations regarding the capacitance as described above with reference to FIG. 1 that is included as part of a discrete representation of the model (step 72). The discrete representation of the model is transformed into a continuous representation of the model (step 73), as described above with reference to FIG. 1. Gauss-Hermite quadrature is applied to the continuous representation of the model to compute variables of the model (which are expressed as expectations of functions of Gaussians random vectors) and a function describing the dependence of capacitance between two chiplets is defined based on the simulations regarding the capacitance between the two chiplets, as described above with reference to FIG. 1 (step 74), ending the routine 70.

To demonstrate the feasibility of the approach of the system of FIG. 1 and the method of FIG. 8 and provide insights on the evolution of the electric field that enables the particles to reach the target distribution, the. following results obtained using the system of FIG. 1 and the method of FIG. 8 are presented. By considering different initial and target densities, electric potential patterns that can be encoded and used in real-time can be discovered. Global parameterizations are used for both the particle trajectories and electrodes electric potentials x. In particular, the vector of positions Z: [0,T]→R²ⁿ, with Z=[x⁽¹⁾, . . . , x⁽ⁿ⁾], and the electric potentials V: R²× [0,T]→R are defined as NNs. One advantage of this type of parameterization is that batch execution can be used to evaluate the particle positions and the electric potential at a sequence of time instances and positions, jointly. Another advantage is that there is no longer the need to explicitly discretize the particle dynamics because automatic differentiation can be used to evaluate the time derivatives. To ensure scalability with the number of optimization variables, a first order gradient-based algorithm (“Adam”) described by Diederik P. Kingma and Jimmy Ba. Adam: “A method for stochastic optimization,” 2014. cite arxiv:1412.6980 Comment: Published as a conference paper at the 3rd International Conference for Learning Representations, San Diego, 2015, the disclosure of which is incorporated by reference, was used, and the optimization problem was recast in primal-dual flavor. The loss function is minimized as follows:

$${\sum }_{i , j} {( \frac{1}{n} {\sum }_{l = 1}^{n} {K}_{H} ( {x}_{i , j} - {x}^{( l )} ( T ) ) - {f}_{d} ( {x}_{i , j} ) )}^{2} + λ {\sum }_{l = 1}^{n} {\sum }_{k , i , j} {‖ {\dot{x}}_{{t}_{k}}^{( l )} - F ( {x}^{( l )} ( {t}_{k} ) , 𝒱 ( {x}_{i , j} , {t}_{k} ) ) ‖}^{2} ,$$

in terms of the weights and biases of the NNs, using Adam. The bounds constraints 26 on the particle positions and electric potentials are imposed through projections. Periodically, the weight of the constraint λ is updated to reflect how far the result is from satisfying the constraint 26, using a projected gradient step:

λ←[λ+α(Σₗ₌₁ⁿΣ_{k,i,j}∥\dot{x}ₜ_{ₖ}^{(l)}−F(x^{(l)}(tₖ), [symbol] (x_{i,j}tₖ))∥²−ϵ)]₊,

for a positive stepsize α and a small positive scalar ε, playing the role of tolerance.

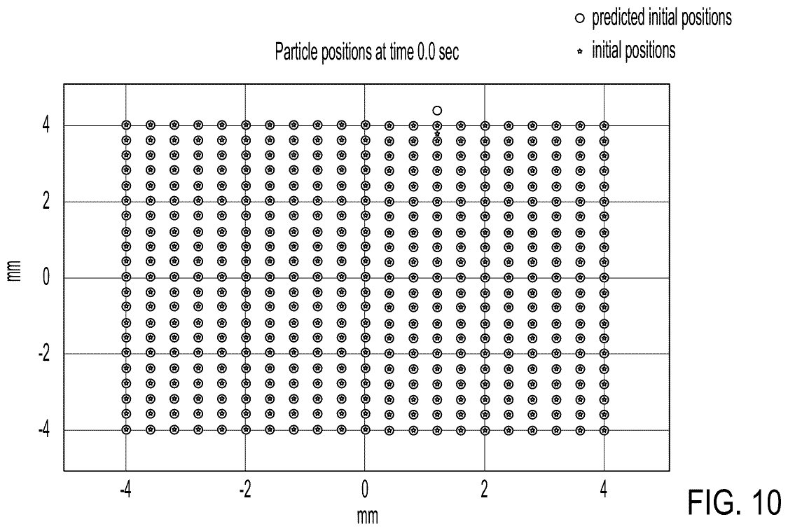

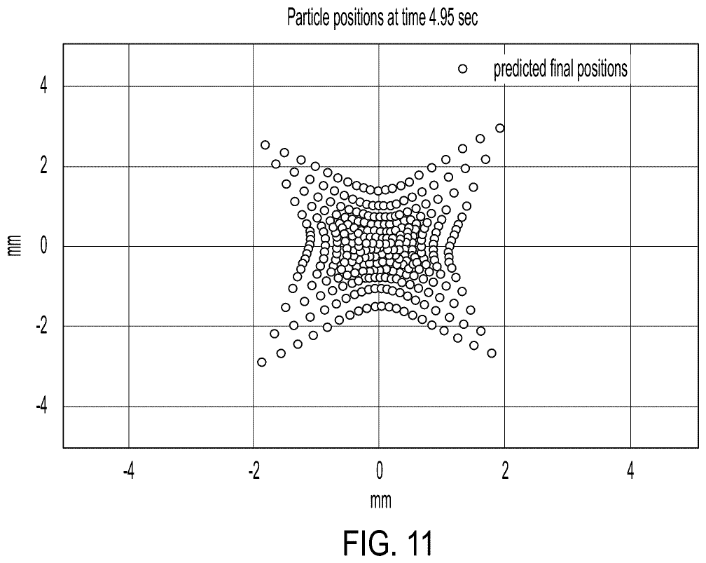

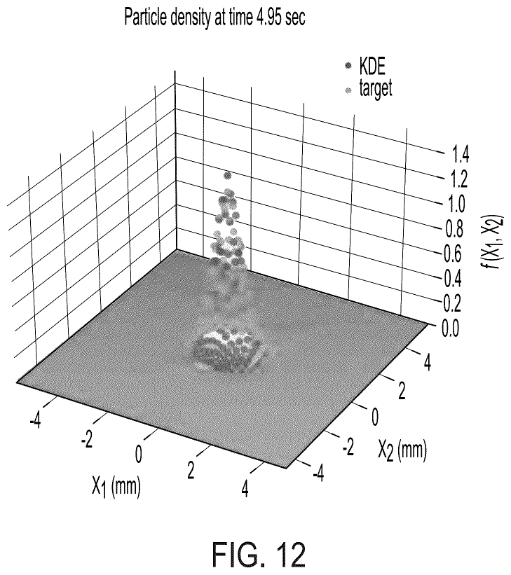

In the simulation results, the following was considered: [symbol] =5 mm×5 mm, and the electrodes are uniformly distributed, with 0.25 mm electrode pitch, resulting in 1680 electrodes. The maximum electrode potential magnitude is 400V. The particle capacitance is a multivariate, Gaussian distribution with mean at the particle position x and covariance matrix σ²I, where σ=0.25×10⁻³. A time horizon of 5 seconds and a sampling period of 0.05 msec were considered. An assumption was made that the camera is able to identify the positions of 450 particles and that these positions will be used as initial conditions in the optimal control problem. Two NNs were used to model each of the x₁ and x₂ directions of the particle positions. These NNs have one hidden layer of size 1500, using tanh as activation function. The electric potential map [symbol] is modeled as a NN with a hidden layer of size 500 and tanh as activation function. Note that while the complexity of the NN modeling the map [symbol] can remain constant, the complexity of the NNs modeling the particle positions over time will depend on the number of particles. The target particle distribution was set to a multivariate Gaussian distribution centered at zero, with covariance matrix σ²I, where σ=0.5×10⁻³. The bandwidth parameter is chosen as h=1.06σn^{-1/5}, where n is the number of particles. In addition, the tolerance for satisfying the particle dynamics constraint was set to ε=10⁻⁴. Note that this tolerance is significant considering that the tolerance is applied to the sum (not the average) of more than 10⁷ residuals, when accounting for the number of particles, time samples, and grid points at which the electric potentials are evaluated. The initial particle density distribution is from a perfect uniform particle distribution, as shown in FIG. 1. FIG. 10 is a diagram showing, for purposes of illustration, initial positions of a plurality of particles. After solving the optimal control problem, the particle positions after 4.95 seconds are shown in FIG. 11. FIG. 11 is a diagram, showing for purposes of illustration, positions of the particles of FIG. 10 after 4.95 seconds. The positions are computed by evaluating the trained NNs at the end of the time horizon. In FIG. 12, both the initial conditions predicted by the NNs and the true initial conditions are plotted, showing that the NNs perfectly match the ground truth. FIG. 12 is a diagram depicting a comparison between the target density and the KDE computed using the particle positions, at the end of the time horizon. The MSE between the KDE and the target density is 6.7×10⁻⁴. The MSE is well in the range of errors obtained by sampling from the Gaussian distribution and computing the KDE using these samples.

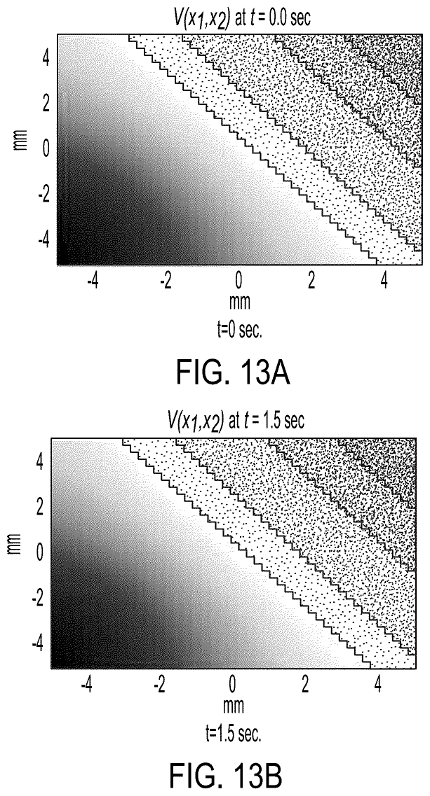

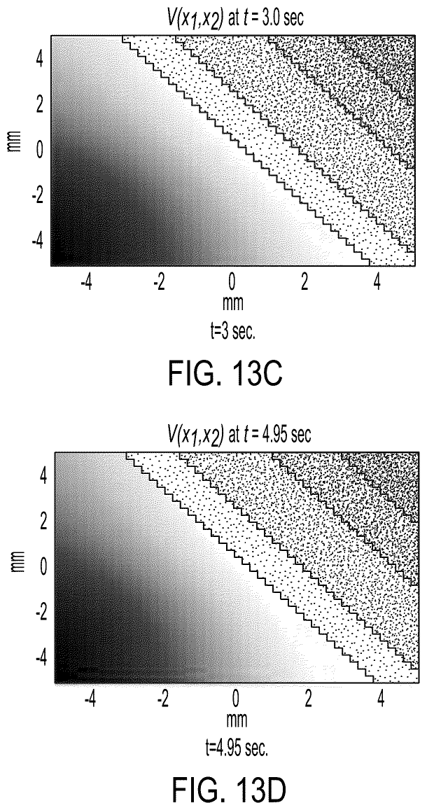

FIGS. 13A-13D are diagrams showing the electric potential changes over the time horizon for four time samples. The stippled (right side of the graphs) portions and grayscale (left side of the graphs) portions represent negative and positive potentials, respectively The darker the grayscale colors in a portion of the figure, the greater the magnitude of the potentials being in that portion of the figure. The denser the stippling is in a portion of a figure, the larger is the potential magnitude in that portion of the figure. Interestingly, the plots show a clockwise rotation of the potential distribution over time. The results for the electric potentials are not unique and depend on the type of parameterization we use. As the complexity of the NN is increased, a larger class of control inputs can be modeled while increasing the complexity of the optimization problem. The NN modeling the behavior of the electrode potentials over time has a total of 2501 parameters. Had the control inputs at each electrode and each time sample been considered, there would be more than 1.6×104 optimization variables just for the control input. To obtain the architecture described above (NNs were used to model each of the x₁ and x₂ directions of the particle positions. These NNs have one hidden layer of size 1500, using tanh as activation function. The electric potential map [symbol] is modeled as a NN with a hidden layer of size 500 and tanh as activation function), a parsimonious approach was used in regards to the architecture of the neural network: a simple, one hidden layer architecture was used at the start and the complexity of the architecture (i.e., the size of the hidden layer) increased until a satisfactory result was obtained. The same approach was used for modeling the particle positions.

Above is addressed the problem of shaping the distribution of particles immersed in a dielectric fluid, by manipulating an electric field controlled by an array of electrodes. KDE is used to approximate the particle density, where the dynamics of a particle was determined using a 2D capacitive-based model of motion. A probabilistic view for interpreting the particle dynamics for an arbitrarily large number of electrodes is provided. In addition, how Gauss-Hermite quadrature can be used to accurately approximate the potential energy of the particle is shown. An optimal control problem that minimizes the L2 norm between the particle density at the end of a time horizon and a target density is formulated, having the particle dynamics as constraint. Automatic differentiation is used to compute derivatives of physical quantities (e.g., potential energy) and the gradient of the cost and constraint functions. The approach is demonstrated by shaping the density of particles from a uniform to a Gaussian distribution. In a further embodiment, compare the use of KDE-based approach can be substituted in an optimal control formulation that uses the Liouville equation, as dynamical constraint.

While the invention has been particularly shown and described as referenced to the embodiments thereof, those skilled in the art will understand that the foregoing and other changes in form and detail may be made therein without departing from the spirit and scope of the invention.

What is claimed is:

1. A system for micro-object density distribution control with the aid of a digital computer, comprising:
one or more processors configured to execute computer-executable code, one or more of the processors configured to:
obtain one or more parameters of a system for positioning a plurality of micro-objects, the system comprising a plurality of electrodes, the electrodes configured to induce a movement of the micro-objects when the micro-objects are suspended in a fluid proximate to the electrodes upon a generation of one or more electric potentials by one or more of the electrodes;
define using the parameters a model describing a change of positions of the micro-objects due to capacitance-based interactions of the micro-objects with the electrodes;
estimate a density distribution of the micro-objects using kernel density estimation and at least one sensor;
obtain a target density distribution of the micro-objects;
solve an optimal control problem to derive based on the model, the target density distribution, and the estimated density distribution a sequence of the electric potentials for moving at least some of the micro-objects to minimize an error between the estimated density distribution and the target density distribution; and
actuate at least some of the electrodes to generate the sequence of the electric potentials, wherein at least some of the micro-objects are moved upon the generation of the electric potentials.

2. A system according to claim 1, the one or more processors further configured to:
define a discrete representation of the model based on the parameters;
transform the discrete representation into a continuous representation of the model; and
apply Gauss-Hermite quadrature to compute variables of the model.

3. A system according to claim 2, the one or more processors further configured to:
perform a plurality of simulations of capacitance between the electrodes and one or more of the micro-objects; and
define a function comprised in the model and describing the capacitance between the micro-object and each of the electrodes as a function of a distance between the micro-object and that electrode.

4. A system according to claim 3, wherein the model describes the change of the positions in at least one of one dimension and two dimensions.

5. A system according to claim 1, wherein the error between the estimated density distribution and the target density distribution is expressed using an L2 norm metric.

6. A system according to claim 1, wherein solving the optimal control problem comprises performing automatic differentiation to compute a plurality of gradients.

7. A system according to claim 1, wherein solving the optimal control problem comprises evaluating at least one expectation using Gauss-Hermite quadrature.

8. A system according to claim 1, wherein the one or more processors comprise at least one of one or more processing units (GPUs) and one or more tensor processing units (TPUs).

9. A system according to claim 1, wherein two or more of the processors work in parallel to solve the control optimization problem using at least one first order optimization algorithm.

10. A system according to claim 1, wherein each of the electrodes is controlled by a photo-transistor, the one or more processors further configured
control the video projector to project the one or more images to the photo-transistors, wherein the phototransistors control the electrodes to generate the sequence of the electric potentials in the control scheme based on the projected images.

11. A method for micro-object density distribution control with the aid of a digital computer, comprising:
obtaining, by one or more processors configured to execute code, one or more parameters of a system for positioning a plurality of micro-objects, the system comprising a plurality of electrodes, the electrodes configured to induce a movement of the micro-objects when the micro-objects are suspended in a fluid proximate to the electrodes upon a generation of one or more electric potentials by one or more of the electrodes;
defining by one or more of the processors using the parameters a model describing a change of positions of the micro-objects due to capacitance-based interactions of the micro-objects with the electrodes;
estimating by one or more of the processors a density distribution of the micro-objects using kernel density estimation and at least one sensor;
obtaining by one or more of the processors a target density distribution of the micro-objects;
solving by one or more of the processors an optimal control problem to derive based on the model, the target density distribution, and the estimated density distribution a sequence of the electric potentials for moving at least some of the micro-objects to minimize an error between the estimated density distribution and the target density distribution; and
actuating by one or more of the processors at least some of the electrodes to generate the sequence of the electric potentials, wherein at least some of the micro-objects are moved upon the generation of the electric potentials.

12. A method according to claim 11, further comprising:
defining a discrete representation of the model based on the parameters;
transforming the discrete representation into a continuous representation of the model; and
applying Gauss-Hermite quadrature to compute variables of the model.

13. A method according to claim 12, the one or more processors further configured to:
performing a plurality of simulations of capacitance between the electrodes and one or more of the micro-objects; and
defining a function comprised in the model and describing the capacitance between the micro-object and each of the electrodes as a function of a distance between the micro-object and that electrode.

14. A method according to claim 13, wherein the model describes the change of the positions in at least one of one dimension and two dimensions.

15. A method according to claim 11, wherein the error between the estimated density distribution and the target density distribution is expressed using an L2 norm metric.

16. A method according to claim 11, wherein solving the optimal control problem comprises performing automatic differentiation to compute a plurality of gradients.

17. A method according to claim 11, wherein solving the optimal control problem comprises evaluating at least one expectation using Gauss-Hermite quadrature.

18. A method according to claim 11, wherein the one or more processors comprise at least one of one or more processing units (GPUs) and one or more tensor processing units (TPUs).

19. A method according to claim 11, wherein two or more of the processors work in parallel to solve the control optimization problem using at least one first order optimization algorithm.

20. A method according to claim 11, wherein each of the electrodes is controlled by a photo-transistor, further comprising controlling the video projector to project the one or more images to the photo-transistors, wherein the phototransistors control the electrodes to generate the sequence of the electric potentials in the control scheme based on the projected images.
